(19) United States
(12) Patent Application Publication
(10) Pub. No.: US 2019/0108480 A1
(43) Pub. Date: Apr. 11, 2019

(54) Server System Interoperable With Mobile Devices Providing Secure Communications for Package Delivery

(71) Applicants: Cameron Brock, Sherman Oaks, CA (US); Amir Yamini, Sherman Oaks, CA (US)

(72) Inventors: Cameron Brock, Sherman Oaks, CA (US); Amir Yamini, Sherman Oaks, CA (US)

(21) Appl. No.: 16/150,029

(22) Filed: Oct. 2, 2018

Related U.S. Application Data
(60) Provisional application No. 62/570,009, filed on Oct. 9, 2017.

(51) Int. Cl. G06Q 10/08; G06Q 20/10

(52) U.S. Cl. CPC G06Q 10/0834; G06F 3/0482; G06Q 20/102; G06Q 10/0833

(57) ABSTRACT

Various embodiments of the present technology include a system for package delivery. The system including a secure server operable to communicate bilaterally with at least one payment provider and at least one gateway server electronically communicating with the secure server and including a processor and a memory communicatively coupled to the processor, the memory storing instructions executable by the system to perform a method. The method including receiving a package delivery job request from a customer, the package delivery job request including a time and a location for pickup of a package and providing payment to the driver based on progression of delivery for the package and using at least one payment provider.

### CROSS-REFERENCE TO RELATED APPLICATIONS

This patent application claims the benefit and priority of U.S. Provisional Patent Application Ser. No. 62/570,009, filed Oct. 9, 2017. The aforementioned disclosure is hereby incorporated by reference herein in its entirety including all references and appendices cited therein.

### FIELD OF INVENTION

The present invention pertains to technology for the shipping industry. In particular, but not by way of limitation, the present technology provides systems and methods for the shipping industry sharing economy.

### SUMMARY

In exemplary embodiments, the present technology comprises a system for package delivery, comprising: a) a secure server operable to communicate bilaterally with at least one payment provider; b) at least one gateway server electronically communicating with the secure server and including a processor and a memory communicatively coupled to the processor, the memory storing instructions executable by the system to perform a method, the method comprising: 1) receiving a package delivery job request from a customer, the package delivery job request including a time and a location for pickup of a package; 2) receiving a package delivery job acceptance from a driver using a driver programmable user interface on a mobile device, the package delivery job acceptance based on the package delivery job request; 3) receiving a package delivery job fulfillment from the driver using the driver programmable user interface on the mobile device, the package delivery job fulfillment including confirmation for delivery of the package; 4) receiving tracking progression of delivery for the package using the mobile device of the driver, the tracking progression of delivery for the package comprising monitoring the package delivery job request, the package delivery job acceptance, and the package delivery job fulfillment; 5) sending the package delivery job fulfillment to the customer; and 6) providing payment to the driver based on the progression of the delivery for the package and using the at least one payment provider.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a schematic diagram of an exemplary computing architecture that can be used to practice aspects of the present technology.

FIG. 2 is a schematic diagram of an exemplary logical diagram according to exemplary embodiments of the present technology.

FIG. 3 is a simplified diagram of a general user flow according to exemplary embodiments of the present technology.

FIG. 4 is a simplified diagram of a shipment user flow according to exemplary embodiments of the present technology.

FIG. 5 is a simplified diagram of a driver user flow according to exemplary embodiments of the present technology.

FIG. 6 is a simplified diagram of a go online user flow for a driver according to exemplary embodiments of the present technology.

FIG. 7 is a simplified diagram of system architecture according to exemplary embodiments of the present technology.

FIG. 8 is a diagram of graphical user interfaces for a user to create a shipment according to exemplary embodiments of the present technology.

FIG. 9 is a diagram of a graphical user interface for a driver to go online according to exemplary embodiments of the present technology.

FIG. 10 is a diagram of a graphical user interface to generate a Quick Response code (QR code) to print a shipping label according to exemplary embodiments of the present technology.

FIG. 11 illustrates a computer system according to exemplary embodiments of the present technology.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

In exemplary embodiments, the present technology enables systems for the shipping industry sharing economy, including systems for a driver, a customer and a business owner (administrator). The present technology enables the driver to be able find and claim package delivery jobs, mark them complete, and get paid for their work. The present technology also enables the customer to be able to conveniently schedule and pay for package delivery pickup and shipment without having to deal with the headache of going to the post office. The present technology further enables the business owner to add/manage staff members, see statistics on jobs, and manage payment for employees.

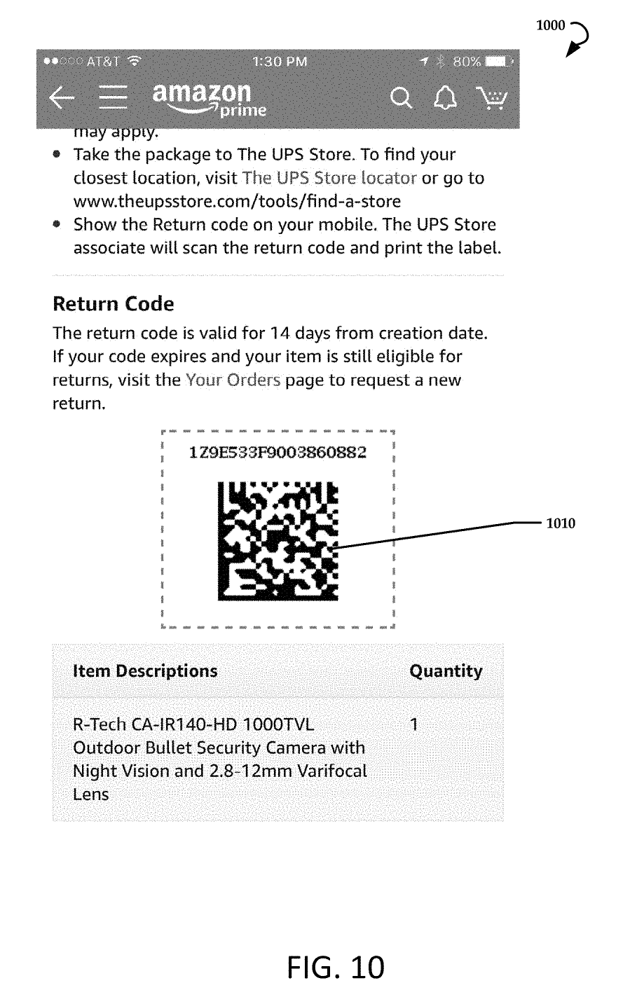

In various embodiments of the present technology, a user can track packages sent out to other vendors. For example, a user can look-up their information on a third-party shipping service (e.g., Amazon) and a user can take a screen-shot of their return label so a driver can show the return label at the drop off location and the drop off location can print the return label. For example, if a user loses their return label and they do not have a printer, the user can take a screen shot of the return label and send it to the driver to print the return label. In some embodiments, a driver programmable user interface is configured to perform displaying of a quick response code, the quick response code being a signifier to a shipping service for printing a delivery job request shipping label. For example, an exemplary QR code is shown for printing a delivery job request shipping label is shown in FIG. 10.

In some embodiments, an owner or user may want to track all shipments sent to third-party shipping services (e.g., Amazon), so the owner or user can get credit for all packages returned to the third-party shipping services.

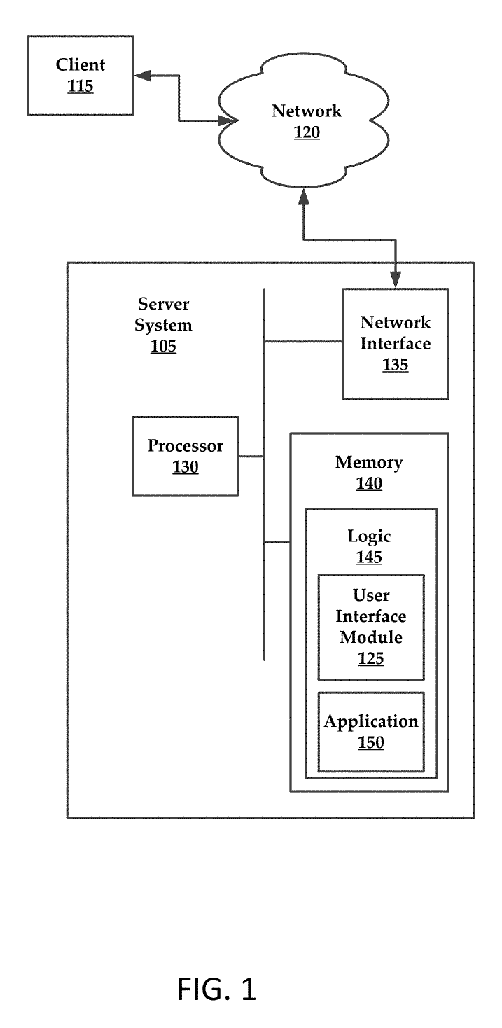

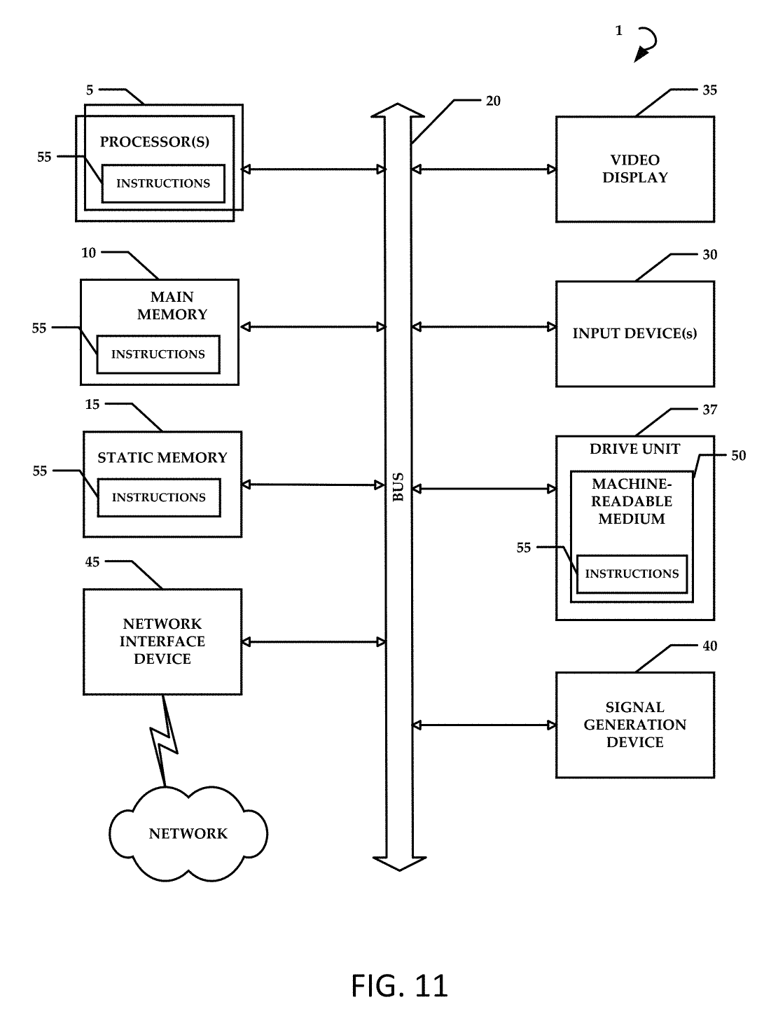

FIG. 1 illustrates an exemplary architecture for practicing aspects of the present technology. The architecture comprises a server system, hereinafter “system 105” that is configured to provide various functionalities, which are described in greater detail throughout this document. Generally the system 105 is configured to communicate with client devices, such as client 115. The client 115 may include, for example, a personalized mobile device, or other similar computing device. An example of a computing device that can be utilized in accordance with the present technology is described in greater detail with respect to FIG. 11.

The system 105 may communicatively couple with the client 115 via a public or private network, such as network 120. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 120 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

The system 105 generally comprises a processor, 130, a network interface 135, and a memory 140. According to some embodiments, the memory 140 comprises logic (e.g., instructions) 145 that can be executed by the processor 130 to perform various methods. For example, the logic may include a user interface module 125 as well as a data aggregation and correlation application (hereinafter application 150) that is configured to provide the functionalities described in greater detail herein.

It will be understood that the functionalities described herein, which are attributed to the system 105 and application 150 may also be executed within the client 115. That is, the client 115 may be programmed to execute the functionalities described herein. In other instances, the system 105 and client 115 may cooperate to provide the functionalities described herein, such that the client 115 is provided with a client-side application that interacts with the system 105 such that the system 105 and client 115 operate in a client/server relationship. Complex computational features may be executed by the system 105, while simple operations that require fewer computational resources may be executed by the client 115, such as data gathering and data display.

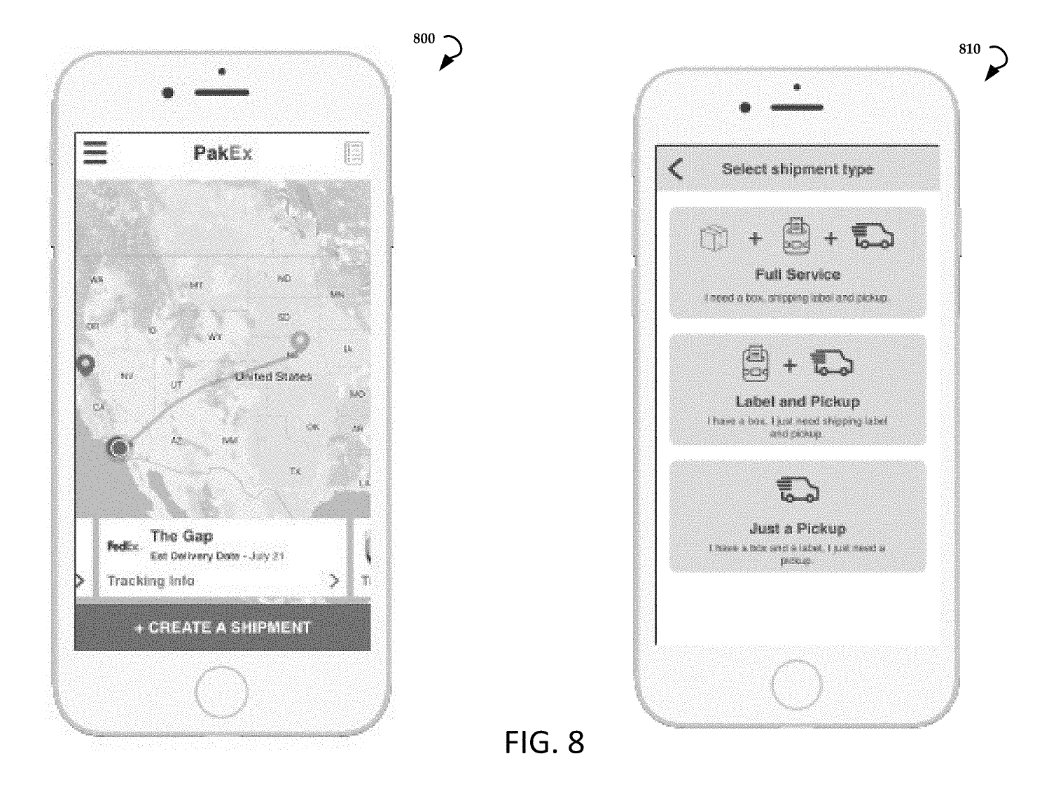

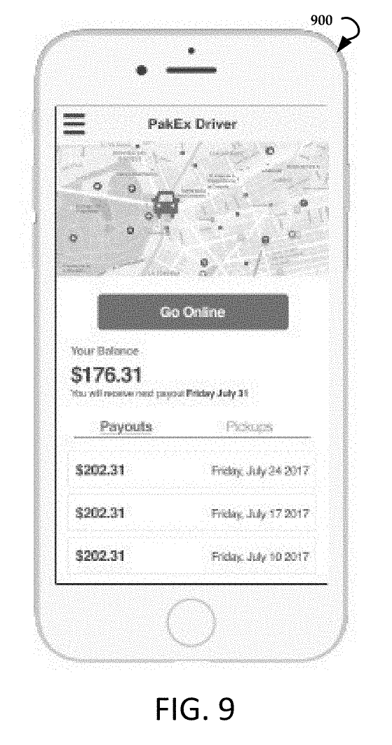

In general, the user interface module 125 may be executed by the system 105 to provide various graphical user interfaces (GUIs) that allow users to interact with the system 105. For example, the mobile frames shown in FIG. 8 and FIG. 9. In some instances, GUIs are generated by execution of the application 150 itself. Users may interact with the system 105 using, for example, a client 115. The system 105 may generate web-based interfaces for the client.

In various embodiments the present technology encompasses systems for the shipping industry sharing economy. The client 115 provides a plurality of GUIs that allow a user to interact with, and use features of the present technology described herein. For instance, the exemplary mobile frames shown in FIG. 8 and FIG. 9. FIG. 11 illustrates a computer system according to exemplary embodiments of the present technology.

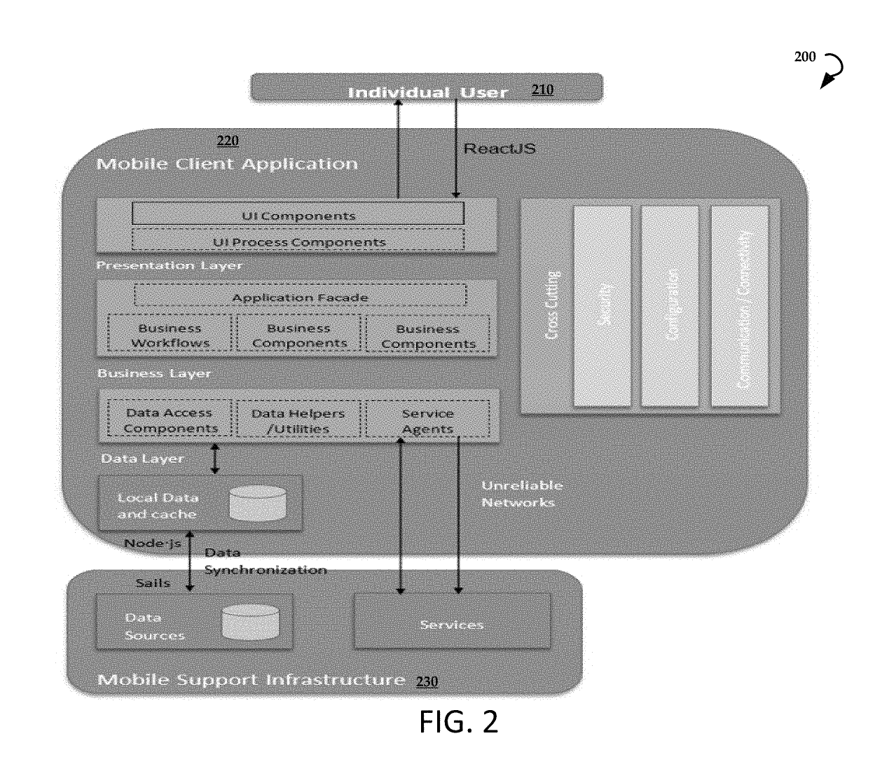

FIG. 2 is a schematic diagram of an exemplary logical diagram 200 according to exemplary embodiments of the present technology. The logical diagram 200 comprises an individual user 210, a mobile client application 220, and a mobile support infrastructure 230. The mobile client application 220 comprises a presentation layer, a business layer, a data layer, and local data and cache. The presentation layer comprises a user interface (UI) components (e.g., user interface module 125) and UI processing components. The business layer comprises an application façade, business workflows and business components. The data layer comprises data access components, data helpers/utilities, and service agents. The mobile support infrastructure 230 comprises data sources and services.

In various embodiments, the individual user 210 interacts with the mobile client application 220 using the UI components (e.g., user interface module 125). The data access components of the mobile client application 220 complete data synchronization with the data sources of the mobile support infrastructure 230. The service agents of the mobile client application 220 communicate with the services of the mobile support infrastructure 230 using unreliable networks.

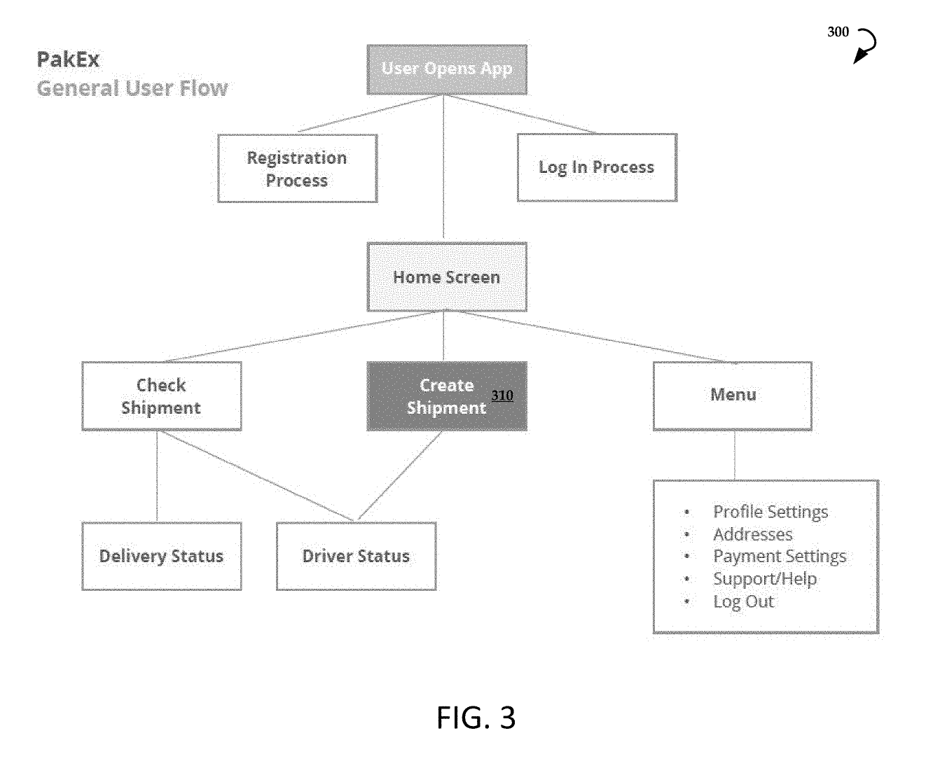

FIG. 3 is a simplified diagram of a general user flow 300 according to exemplary embodiments of the present technology. In various embodiments the general user flow 300 comprises a user opening an application (e.g., application 150) comprising a registration process and a log in process. After the registration process and the log in process, the application includes a home screen. In some embodiments, the home screen comprises check shipment, create shipment 310, and menu functionalities. The check shipment functionality includes delivery status and driver status functionalities. The create shipment 310 functionality also includes the driver status functionality. The menu functionality includes profile settings, address, payment settings, support/help, and log out functionalities.

In various embodiments a user can create and manage a shipment when the user opens the application. For example, after completing the registration process and the log in process, a user can access different functionalities of the present technology including creating a shipment with the create shipment 310 functionality. Additionally, the user can track the shipment with the delivery status and driver status functionalities.

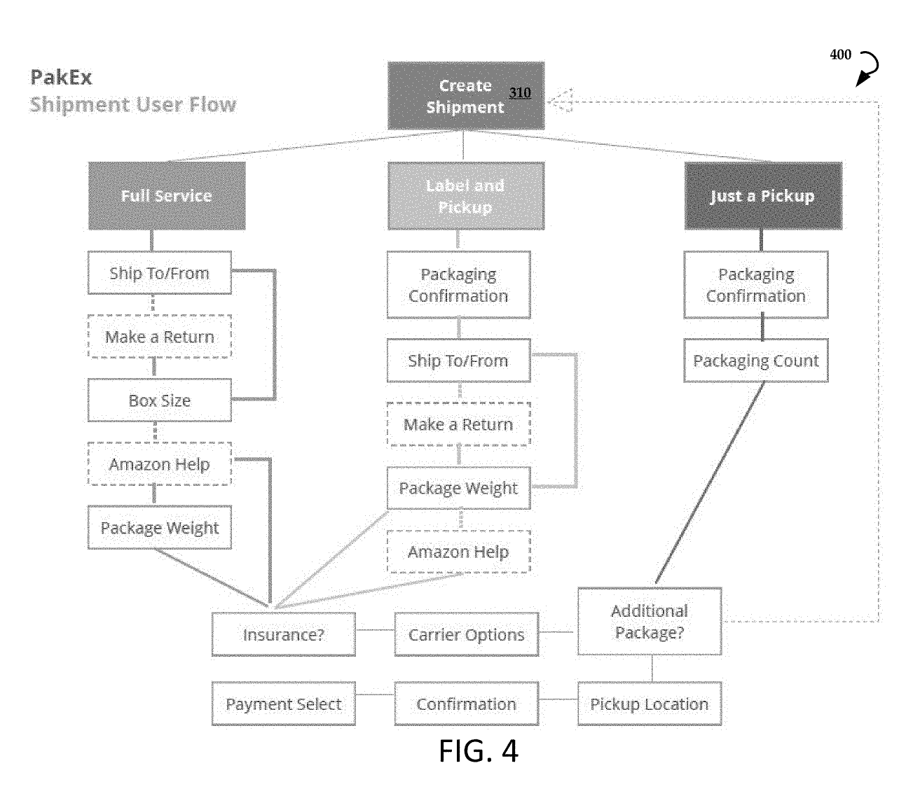

FIG. 4 is a simplified diagram of a shipment user flow 400 according to exemplary embodiments of the present technology. In some embodiments, the create shipment 310 functionality includes full service, label and pickup, and just a pickup functionalities. For example, a user can choose between full service, label and pickup, or just a pickup. The full service functionality comprises ship to/from, optional make a return, box size, optional help, and package weight. After the package weight functionality, the shipment user flow 400 continues with insurance, carrier options, additional package, pickup location, confirmation, and payment select functionalities. In some embodiments, if the user selects the additional package functionality, the shipment user flow 300 goes back to create shipment 310 for the additional package. The label and pickup functionality includes packaging confirmation, ship to/from, optional make a return, package weight and optional help functionalities. After the package weight functionality, the shipment user flow 400 continues with the insurance, carrier options, additional package, pickup location, confirmation, and payment select functionalities. The just a pickup functionality comprises packaging confirmation and packaging count functionalities that are followed by insurance, carrier options, additional package, pickup location, confirmation, and payment select functionalities.

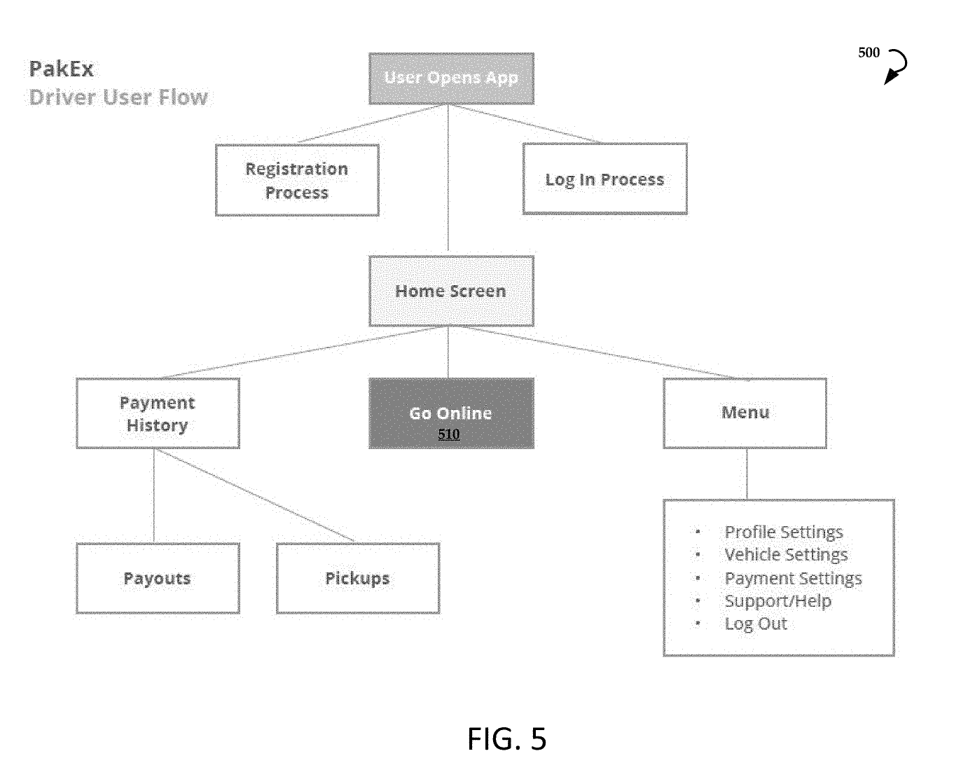

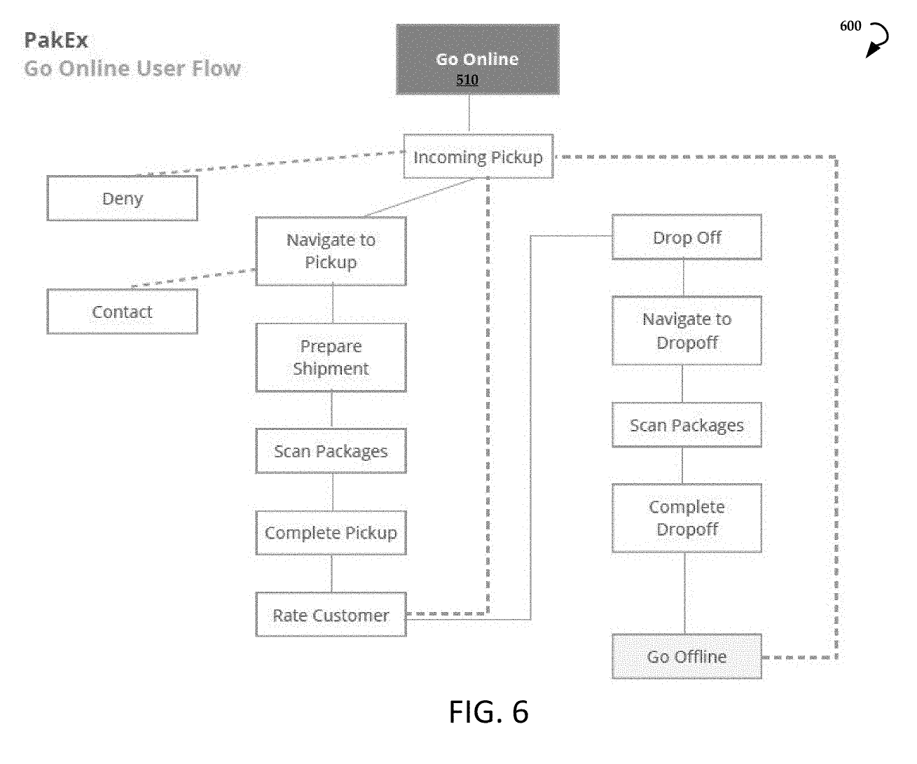

FIG. 5 is a simplified diagram of a driver user flow 500 according to exemplary embodiments of the present technology. In various embodiments the driver user flow 500 comprises a user opening an application (e.g., application 150) comprising a registration process and a log in process. After the registration process and the log in process, the application includes a home screen. In some embodiments, the home screen comprises payment history, go online 510, and menu functionalities. The payment history functionality includes payouts and pickups functionalities. More details regarding the go online 510 functionality are described in FIG. 6. The menu functionality includes profile settings, vehicle settings, payment settings, support/help, and log out functionalities.

In various embodiments a diver can go online when the driver opens the application (e.g., application 150). For example, after completing the registration process and the log in process, a driver can access different functionalities of the present technology including going online with the go online 510 functionality.

FIG. 6 is a simplified diagram of a go online user flow 600 for a driver according to exemplary embodiments of the present technology. The go online user flow 600 includes more details regarding the go online 510 functionality of the driver user flow 500 of FIG. 5. The go online user flow 600 comprises the go online 510 functionality including the incoming pickup functionality. The incoming pickup functionality includes the optional deny functionality and navigate to pick up. The navigate to pick up functionality is followed by the optional contact functionality and prepare shipment, scan packages, complete pickup, rate customer, drop off, navigate to drop-off, scan packages, complete drop-off, and go offline functionalities. In various embodiments a driver can manage a shipment. For example, a diver can manage an incoming pickup by denying the pickup or navigating to the pickup.

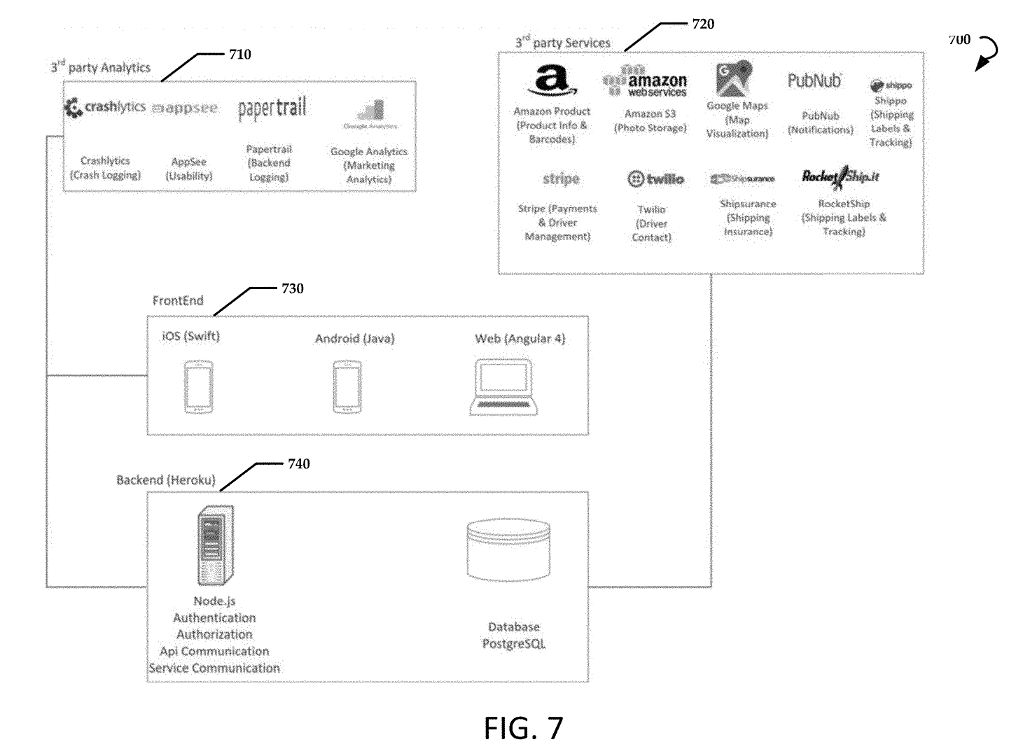

FIG. 7 is a simplified diagram of system architecture 700 according to exemplary embodiments of the present technology. The system architecture 700 includes third-party analytics 710, third-party services 720, frontend 730 and backend 740. For example, the third-party analytics 710 may include crash logging (e.g., Crashlytics), usability (e.g., AppSee™), backend logging (e.g., Papertrail), and marketing analytics (e.g., Google Analytics). For example, third-party services 720 may include product information and barcodes (e.g., Amazon Product), photo storage (e.g., Amazon S3), map visualization (e.g., Google Maps), notifications (e.g., PubNub®), shipping labels and tracking (e.g., Shippo), payments and driver management (e.g., stripe®), driver contact (e.g., Twillo), shipping insurance (e.g., shipsurance), and shipping labels and tracking (e.g., RocketShip). For example, the frontend 730 may include iOS, Android, or a web application platform to enable the functionality described herein. The backend 740 may include cloud platform as a service (PaaS) such as the cloud platform Heroku web application platform to enable the functionality described herein.

FIG. 8 is a diagram of graphical user interfaces for a user to create a shipment according to exemplary embodiments of the present technology. For example, graphical user interface 800 for a user to create a shipment enables the functionality of the create shipment 310 functionality described in FIG. 4. Additionally, graphical user interface 810 shows full service, label and pickup, and just a pickup functionalities of the create shipment 310 functionality as described in FIG. 4.

FIG. 9 is a diagram of a graphical user interface for a driver to go online according to exemplary embodiments of the present technology. For example, graphical user interface 900 for a driver to go online enables the functionality of the go online 510 functionality described in FIG. 5 and FIG. 6. Graphical user interface 900 shows the balance of the account of the driver including payouts to the driver.

FIG. 10 is a diagram of a graphical user interface to generate a QR code to print a shipping label according to exemplary embodiments of the present technology. For example, graphical user interface 1000 shows a QR code 1010 that acts as a form of signifier to a third party shipping service (e.g., USPS, UPS, or FedEx) for return of an item. In some embodiments, the QR code 1010 is generated by a seller (e.g., Amazon, Inc.) with the QR code 1010 being a signifier for return of the item. For example, once a driver finds and claims a package delivery job, the driver scans a QR code (e.g., QR code 1010) to print out a shipping label for return of the item. Thus, the driver uses a QR code (e.g., QR code 1010) to print a shipping label for the package delivery job.

FIG. 11 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network (e.g., network 120, see FIG. 1) via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A system for package delivery, comprising:
a secure server operable to communicate bilaterally with at least one payment provider; and
at least one gateway server electronically communicating with the secure server and including a processor and a memory communicatively coupled to the processor, the memory storing instructions executable by the system to perform a method, the method comprising:
receiving a package delivery job request from a customer, the package delivery job request including a time and a location for pickup of a package;
receiving a package delivery job acceptance from a driver using a driver programmable user interface on a mobile device, the package delivery job acceptance based on the package delivery job request;
receiving a package delivery job fulfillment from the driver using the driver programmable user interface on the mobile device, the package delivery job fulfillment including confirmation for delivery of the package;
receiving tracking progression of delivery for the package using the mobile device of the driver, the tracking progression of delivery for the package comprising monitoring the package delivery job request, the package delivery job acceptance, and the package delivery job fulfillment;
sending the package delivery job fulfillment to the customer; and
providing payment to the driver based on the progression of the delivery for the package and using the at least one payment provider.

2. The system of claim 1, further comprising:
at least one application programming interface electronically communicating with the at least one gateway server and adapted to communicate bilaterally with at least one driver application being executed on the mobile device, the at least one application programming interface further adapted to communicate bilaterally with the driver programmable user interface.

3. The system of claim 2, wherein the driver programmable user interface is configured to perform:
a registration process for the driver; and
a login process for the driver.

4. The system of claim 2, wherein the driver programmable user interface is configured to perform:
a payment history for the driver, the payment history for the driver including the providing of the payment to the driver based on the progression of the delivery for the package and using the at least one payment provider;
going online for the driver, the going online for the driver including scanning the package using the mobile device.

5. The system of claim 2, wherein the driver programmable user interface is configured to perform:
displaying a quick response code, the quick response code being a signifier to a shipping service for printing a delivery job request shipping label.

6. The system of claim 5, further comprising a printer, the printer printing the delivery job request shipping label from the quick response code.

7. The system of claim 1, wherein the at least one payment provider is a third party account.

8. The system of claim 1, further comprising:
at least one application programming interface electronically communicating with the at least one gateway server and adapted to communicate bilaterally with at least one customer application being executed on a mobile device of the customer, the at least one application programming interface further adapted to communicate bilaterally with a customer programmable user interface, the customer programmable user interface configured to perform:
a registration process for the customer; and
a login process for the customer.

9. The system of claim 8, wherein the customer programmable user interface is further configured to perform:
creating a shipment, the creating the shipment being the package delivery job request from a customer and including a full service option, a label and pickup option, and a just pickup option.

10. A computer-implemented method for conducting a secure transaction over a network using one or more gateway servers for delivery of a package, the method comprising:
receiving a package delivery job request from a customer, the package delivery job request including a time and a location for pickup of the package;
receiving a package delivery job acceptance from a driver using a driver programmable user interface on a mobile device, the package delivery job acceptance based on the package delivery job request;
receiving a package delivery job fulfillment from the driver using the driver programmable user interface on the mobile device, the package delivery job fulfillment including confirmation for delivery of the package;
receiving tracking progression of delivery for the package using the mobile device of the driver, the tracking progression of delivery for the package comprising monitoring the package delivery job request, the package delivery job acceptance, and the package delivery job fulfillment;
sending the package delivery job fulfillment to the customer; and
providing payment to the driver based on the progression of the delivery for the package and using the at least one payment provider.

11. The computer-implemented method of claim 10, further comprising:
providing a registration process for the driver; and
providing a login process for the driver.

12. The computer-implemented method of claim 10, further comprising:
providing a payment history for the driver, the payment history for the driver including the providing of the payment to the driver based on the progression of the delivery for the package and using the at least one payment provider.

13. The computer-implemented method of claim 10, further comprising:
providing going online for the driver, the going online for the driver including scanning the package using the mobile device.

14. The computer-implemented method of claim 10, wherein the at least one payment provider is a third party account.

15. The computer-implemented method of claim 10, further comprising:
providing a registration process for the customer; and
providing a login process for the customer.

16. The computer-implemented method of claim 10, further comprising:
creating a shipment for the customer, the creating the shipment being the package delivery job request from the customer and including a full service option, a label and pickup option, and a just pickup option.

17. A non-transitory computer-readable storage medium having embodied thereon a program, the program being executable by a processor to perform a method for conducting a secure transaction over a network, the method comprising:
receiving a package delivery job request from a customer, the package delivery job request including a time and a location for pickup of a package;
receiving a package delivery job acceptance from a driver using a driver programmable user interface on a mobile device, the package delivery job acceptance based on the package delivery job request;
receiving a package delivery job fulfillment from the driver using the driver programmable user interface on the mobile device, the package delivery job fulfillment including confirmation for delivery of the package;
receiving tracking progression of delivery for the package using the mobile device of the driver, the tracking progression of delivery for the package comprising monitoring the package delivery job request, the package delivery job acceptance, and the package delivery job fulfillment;
sending the package delivery job fulfillment to the customer; and
providing payment to the driver based on the progression of the delivery for the package and using the at least one payment provider.

18. The non-transitory computer-readable storage medium of claim 17, wherein the method further comprises:
providing a payment history for the driver, the payment history for the driver including the providing of the payment to the driver based on the progression of the delivery for the package and using the at least one payment provider.

19. The non-transitory computer-readable storage medium of claim 17, wherein the method further comprises:
providing going online for the driver, the going online for the driver including scanning the package using the mobile device.

20. The non-transitory computer-readable storage medium of claim 17, wherein the method further comprises:
creating a shipment for the customer, the creating the shipment being the package delivery job request from the customer and including a full service option, a label and pickup option, and a just pickup option.
